(19) United States
(12) Patent Application Publication
(10) Pub. No.: US 2017/0199505 A1
(43) Pub. Date: Jul. 13, 2017

(54) PRE-POPULATED CONTAINERIZED MODULE OF SUBASSEMBLY AND COMPONENTS FROM WHICH TO CONSTRUCT LARGE-SCALE INDUSTRIAL FACILITIES

(71) Applicant: MODULAR EYES INC., Calgary (CA)

(72) Inventor: ROSS HARPER, Calgary (CA)

(21) Appl. No.: 14/992,482

(22) Filed: Jan. 11, 2016

(51) Int. Cl. G05B 19/18

(52) U.S. Cl. CPC G05B 19/188; G05B 2219/32019

(57) ABSTRACT

This invention is aimed at enhancing manufacturing and fabrication of componentry for large scale industrial or processing facilities (for example) by tailoring prefabrication of modules suitable for both: a) shipment and logistics advantages enjoyed by container transport and transshipment systems; and b) convenient and safe, efficient assembly to working end-state on-site. In particular, this is aimed at providing pre-populated subassemblies as modules with multi-modal container-like characteristics for shipping, transshipping and inventorying, but which are pre-built to a large extent to include pre-positioned and connected wiring, piping, tubing, valves, electrical and signal conduits, control systems, flooring and lighting, equipment such as pumps and motors, filters, process vessels, heaters and the like; each such pre-populated module can be attached to one or more other modules, or to a larger industrial facility, to quickly and with maximum exactness and efficiency, and safely develop and build-out the industrial facility.

### FIELD OF THE INVENTION

This invention is aimed at enhancing manufacturing and fabrication of componentry for large scale industrial or processing facilities (for example) by tailoring prefabrication of modules suitable for both: a) shipment and logistics advantages enjoyed by container transport and transshipment systems; and b) convenient and safe, efficient assembly to working end-state on-site. In particular, this is aimed at providing pre-populated subassemblies as modules with multi-modal container-like characteristics for shipping, transshipping and inventorying, but which are pre-built to a large extent to include pre-positioned and connected wiring, piping, tubing, valves, electrical and signal conduits, control systems, flooring and lighting, equipment such as pumps and motors, filters, process vessels, heaters and the like; each such pre-populated module can be attached to one or more other modules, or to a larger industrial facility, to quickly and with maximum exactness and efficiency, and safely develop and build-out the industrial facility.

### BACKGROUND OF THE INVENTION

### A. Prefabricated Construction—Industrial or Processing Facilities

It is known in the construction industry, in both residential and commercial or industrial segments, to pre-fabricate either sub-components or whole buildings in factory settings for delivery and assembly at a building site.

In the residential setting, prefabricated housing might include things like “double-wide” trailerable buildings (Mobile Homes), which are manufactured and populated with furnishings and fixtures in a factory setting, packaged for delivery, for example on trailers, and delivered over conventional roadways to a building site, which has been prepared by installation of utilities and foundation works, to which the building can be fixed and attached. (see Champion Homes http://www.championhomes.com/)

In industrial settings, major industrialized plants such as heavy oil upgraders and SAGD plants in prefabricated components have been provided in modularized form. An example of SAGD components can be seen as those built and delivered by Oak Point Energy Ltd., Alberta, Canada (see www.oakpointenergy.ca/technology/1nsite-sagd), which provides modules of equipment such as steam generation plant(s) to be assembled and connected to associated water, gas, steam, control and electrical conduits, insulation, and connectors, and which are sized for road transport. The modules are constructed in lower cost labour centers away from their eventual operational field site, and can theoretically be moved and reconfigured if it is decided to move them again from the initial site to another site (for instance, as the wells at the first site decline in production and the equipment is then more economically used at a second site).

The major constraints on both residential and industrial large-scale prefabricated construction technologies has been the maximum roadway width, trailer height and length (regulatory regimes, bridge and overhead clearances), and roadbed weight-bearing capacity on the route proposed between the manufacturing site and the construction site. Typically sea side operating sites may have modules ranging from 100 tonnes to 5000 tonnes. However, in North America non-coastal regions modules must be much smaller and lighter, being limited by transportation means used, being roadways.

Of course, there is also another type of prefabrication practice which is exemplified by log buildings, which are designed to be cut and assembled on a site near to the source of timber, then labeled and disassembled for shipment to an eventual building site to be re-assembled. This type of partial prefabrication is also limited by the capacity of the shipping means between the originating site and the eventual building site, and the prefabrication cannot be as complete (for instance, this method can't usually configure wiring, plumbing, fixtures and appliances in the “factory”) since the degree of disassembly for shipping is too extensive. This “log building” method is most like the current stage of development of modularized industrial facilities construction, where piping spools and structural steel components are fabricated in a lower cost labour center and transported by road to the operating site for installation of pre-assemblies, and then wired, plumbed, and populated with larger equipment.

Equipment such as doghouses built to house and protect production or collection subsystems (well-heads, valves, pumps, etc.) in the oil industry, which are typically small, metal clad insulated structures where sensing or control equipment required for field operations is installed for protection, are also known. These are smaller buildings, typically prefabricated in a shop and delivered, most typically by truck over roadways, to the desired site location for attachment for operation and are typically referred to as “skids” as they are single story structures designed to be lifted and placed from the bottom, resting on a skid or rail on their bottom side, and have limited upper structures. These have little relevance to the subject-matter of this invention.

### B. Containerization and Shipping Logistics

There exists a global logistics and transportation system based upon standardized shipping containers, commonly called “Seacans”, or “intermodal containers” or “multi-modal” containers. An example of a supplier of this type of container is Sea-Can Containers Ltd. of Edmonton, Alberta. The majority of Seacans are currently manufactured in Asia by such companies as Big Steel Box and Shanghai Metal Corporation.

Seacan containers are, in their most usual and essential configuration, closed steel containers of standard height, length, and width with a closable door at one end, most typically being sufficiently load-bearing to be capable of being stacked, and also including fittings (called corner castings) of standardized configuration and placement (typically at each corner) so that a number of Seacans can be fastened to one another at load- and attachment-points, or single Seacans can be fastened to transport vehicles such as wheeled dolleys or trailers, and can be fastened to overhead lift equipment (cranes, trolleys) for transshipment and loading/unloading from various modes of transportation (ships, trains, truck-tractors, etc.).

Seacans are standardized for international inter-modal shipment and for the transshipment from mode-to-mode at specialized ports using highly automated equipment and logistics management systems. Seacans will themselves most typically be loaded by being filled at an end-point (the beginning of its trip) and the door closed and sealed and then not unloaded until the other end-point of its trip (its destination) where it will be unloaded and its contents further distributed, with an unchanged cargo manifest through the life of the Seacan's journey.

The advantages of this system are very high speed and very low cost shipment of materials or goods over long distances using whatever mode of transport is most efficiently available for each segment of the Seacan's journey—enabled by automated logistics management systems (load-tracking, route management, import-export permitting, delivery-receipt tracking, etcetera) and automated handling of standardized packages (containers) which themselves form part of the physical transport mechanisms (e.g. containers may be stacked on each other and secured, without necessity of racks or individual mounting points on a container ship, for instance), and are of a standard size for which shipping mode transport equipment can also be standardized in design (dolley or trailer mounts, crane and hoist spreader and automated attachment/detachment mechanisms, railcar size with mount point locations, container ship hold and deck design for mounting points, load-bearing structures, etc.).

The increased velocity of transported goods which containerized systems enables (that is, the time in transport has been dramatically reduced, along with other costs such as handling, demurrage, etcetera), has had the effect of pushing inventory out of commerce in many realms, by permitting “just-in-time” manufacturing and delivery of component parts within a supply chain. This has led to globalization of the supply chain, where manufacturing of components within the supply chain for an end-product can be done at any location in the world, in turn enabling arbitrage for lowest cost materials, labor, overhead and design, as well as for capacity if time from order to shipment is a constraint.

The standardized size and mount/load points in Seacan transport systems has accommodated many designs, including things like refrigerated containers with the refrigeration equipment mounted inside the standard dimensional envelope for Seacans, with external ports or connectors for power, etc. In addition, enclosing the cargo in a Seacan for transport provides security against environment (water, rust, contamination), theft or interference/vandalism, exposure (trade secrets), and other threats.

Although the history of standard dimensions began differently in North American and Europe, a modern standard Seacan will have the following sorts of characteristics: width, length and height within an envelope of dimensions so that the “box” of the Seacan is capable of being transported on standard container ship, highway and railway using relatively conventional (although now more purpose-built) trailers, trollies or railcars, and Seacans may be stacked and should be relatively automatically aligned and attached to the vehicle (and each other); loading and unloading capabilities (at least one sealable or lockable door with hinges recessed within the rear corner posts rather than protruding from the exterior side, interior dimensions amenable to carriage of goods and loading/unloading of the Seacan itself; load-bearing and containment capabilities (that is, stackable/jackable, lift-able from predesigned lift points)). These requirements are met with modern Seacan characteristics: for example, common lengths are 20, 40 and 53 feet. Also, the container will have a heavy steel post at each corner to support the weight of more containers stacked on top of it, as well as to provide structural support for lifting and manipulation forces. At the top and bottom of each steel (corner) post is a mating forged handling lug or fitting which permits alignment and interlocking/connection of a container to an adjacent container (above or below) for stacking and attachment—these fittings are also suitable to attach the container to a vehicle (trailer, railcar, dolly) or a lifting or manipulation device (cable-spreader-crane) at a transshipment facility.

One problem with containerized transport systems is a buildup of inventory of Seacans. Sufficient containers need to be in existence to accommodate the bulk traffic, as well as in any back-haul trade. In operation, over time, periodic surpluses of Seacans have come into existence, and surplus or used Seacans (for example, containers which are past their useful life in transport business) are seen being repurposed as construction components, storage units, or sculpture (or waste).

### C. Oilfield Industrial Construction

In modern industrial-scale facilities being constructed at oilfield locations, for instance SAGD plants at or near multiple well-heads for both production and injection of steam and recovery of bitumen, a relatively large-scale facility is required. Process equipment for the production of heavy oil using SAGD (which is used here as a meaningful example of the state of the art and later, of an embodiment of the invention of this application), can include water gathering and holding systems, water treatment systems, electrical distribution systems, steam generation systems, steam injection and handling systems, production systems with heaters and pumps, chemical and solvent receiving and recycling, processing, and management systems, production holding, treatment and heating systems, and heavy oil or dil-bit transport systems whether to truck, railcar or pipeline.

Each of these systems is interconnected, by virtue of being itself part of the system of injection of heat energy via steam /solvent or a combination of both into a well array to heat in situ heavy oil to the point where the oil can be flowed in production back to surface typically via a second complementary well array (forming SAGD well-pairs, for example) and then conditioned for transport and transported to market.

Each system has a number of inputs, whether fresh or recycled water, energy such as electrical or gas-power for steam generation or power for pumping or other operations, hydrocarbon from production or diluent from external suppliers or from local recycle systems. Each has a number of outputs, such as water, steam, produced hydrocarbon, power, effluent, or dil-bit. Each input and output must be managed and controlled, delivered or received, and these activities involve the use of many pipes, manifolds, valves, conduits, communications channels, power transmission lines, switches and controllers, sensors and meters and the like, each of which must be routed, installed and supported (physically) in the facility's structural environment.

The various functions in a SAGD facility (by way of example) are also interconnected and co-ordinated, as are most modern industrial facilities.

As may be appreciated, this type of exemplary industrial facility, in this example in an oilfield application, may be required to be constructed in a remote area, far away from industrial-scale or even controlled-environment fabrication and assembly facilities. We refer here to this type of facility as “facilities for large-scale industrial equipment and associated features (such as conduit, passageways, manways, pipelines, cable-ways, etc.)”, sometimes qualified as “civil engineering scale”, to point out to the reader that they are more akin to bridges and infrastructure than they are to habitable environments or housing.

In the prior art, parts must be shipped to the facility's site, some partially assembled, and then racking and support structures built, and pipe, conduit, and wiring must be run to larger pieces of equipment, which are typically delivered on baseframes or skids which can be mounted to foundations, and connected; control systems installed and tested; and finally, the plant may be commissioned after testing.

This is a complex process, piping and electrical cable may be delivered in bulk and cut and assembled (or may be pre-cut to designed length). Many on-site personnel are required, of various trade skills, working at heights above grade, and the use of lifting equipment, temporary scaffolding, and related safety and assembly risk is ever-present.

In typical industrial applications within the prior art, where large subassemblies are used to provide cable trays and their support systems (an example of the type of constructed thing which this invention handles differently, as a prepopulated containerized module), these are designed to be built off-site but within road-transportable range, and are fabricated as 36 m×7.3 m×7.5 m structures, sized for maximum permitted vehicle/trailer transport over roadways. These large sub-assemblies are then shipped to the remote construction site, which is the eventual industrial facility's location, on specialized transporters, and installed on previously constructed/installed/built frame structures by use of heavy lift crane or lifting equipment. These large subassemblies are most usually one-off designs, purpose-built for the site and facility to which they are delivered, and individually designed—‘bespoke’.

Assembly of these prior art subassemblies takes place in an assembly yard geographically near to the eventual site where they will be used. In Alberta, for example, this might mean a cable tray subassembly destined for Fort McMurray region might be fabricated and assembled in a yard in Edmonton region, transportable by roadway using specialized tractor-trailers and with special routing and permitting required for over-size loads and heavy weights. The fabrication at the Edmonton yard would use expensive Edmonton local labor, of uncertain availability, be subject to variable Edmonton weather and other conditions, and would essentially be a custom fabrication job with little benefit from standardization of global reach for materials or logistics, and dependent upon the size and availability of local (in this example, Edmonton-based) facilities and competencies and subject to high wage rates and costs.

When installed on frameworks previously built at the eventual facility site, these large subassemblies will typically be the last thing installed, and will go in at great height (25 m-40 m above grade), necessitating installation of scaffolding, walkways and safety equipment (dance-floor scaffolding, etc.). There is typically a gap of approximately 6 m between inline large assemblies where scaffolding is required, in this type of construction, and as well trays may need to be pulled between one subassembly and the next one (lengthwise) inline, both well above grade. Also, standard spacing is typically utilized for the cable tray, which means that special additional supports are required 1.5 m inboard on one subassembly and 1.5 m outboard longitudinally for each tray for each subassembly.

In addition, on-site conditions for fabrication and final assembly are less ideal than in a controlled, factory-like setting with climate-control, good lighting, permanent heavy-duty lifting and welding, test and other support equipment on hand. Safety and quality may also be degraded in an on-site fabrication/assembly setting.

### SUMMARY OF THE INVENTION

In an embodiment, the invention is a module, being a prepopulated subassembly of components, the module sized and made to form and function as a standardized inter-modal shipping container, the module capable of use during transport and inventory as a standard shipping container. The module in an embodiment comprises a structure of connected horizontal longitudinal and transverse beams and vertical posts forming a support structure to be part of an industrial facility and populated with at least some of the following: cantilevered arms attached to the vertical posts extending partway to the middle of the support structure, the posts having standard shipping container cast corner lugs both top and bottom; walkways or flooring suspended between adjacent horizontal beams to form workspaces for workers; equipment associated with the subassembly's eventual purpose, being one or more of conduit, pipe, shelving, catwalk, manway, valve, meter, gantry equipment, manifold, pump, automated controls, system interface equipment for operators, connectors, vapor control means, vents, gates, ramps and the like.

The module is manufactured by joining the posts and beams to form a container-shaped box structure of posts, beams and horizontal supports, and then the module may be populated with the other associated equipment and features, at or near the module's place of manufacture. The module is designed as a subassembly for later assembly after shipping as a container using intermodal transport systems, as a part of a facility for large-scale industrial equipment and associated feature, at a facility site.

Generally, the invention provides pre-populated subassemblies as modules with inter-modal container-like characteristics for shipping, transshipping and inventorying, but which are pre-built to a large extent to include pre-positioned and connected wiring, piping, tubing, valves, electrical and signal conduits, control systems, flooring and lighting, equipment such as pumps and motors, filters, process vessels, heaters and the like; each such pre-populated module can be attached to one or more other modules, or to a larger industrial facility, to quickly and with maximum exactness and efficiency, and safely develop and build-out the industrial facility.

### BRIEF DESCRIPTION OF THE DRAWINGS

FIG. 1 is a perspective drawing (not to scale) of a Module comprised of Support Framework Structures (unpopulated) but with cable trays. (another variant could include a cable tray on one side with piping and valves on the opposite side of the interior walkway).

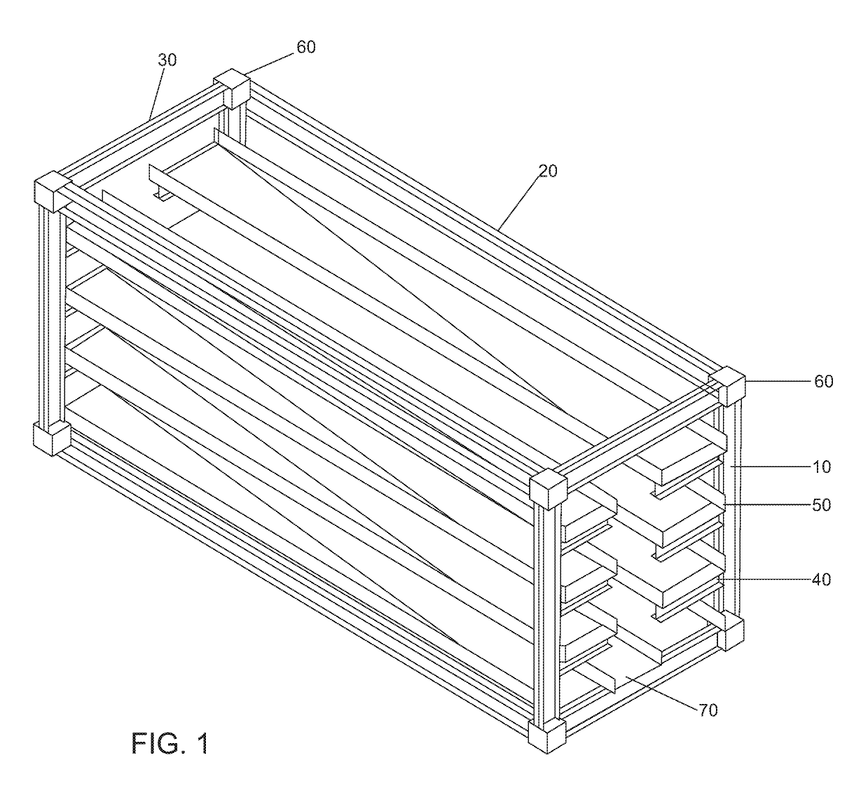

FIG. 2 is an end-on elevation drawing (not to scale) of a Module (partially populated).

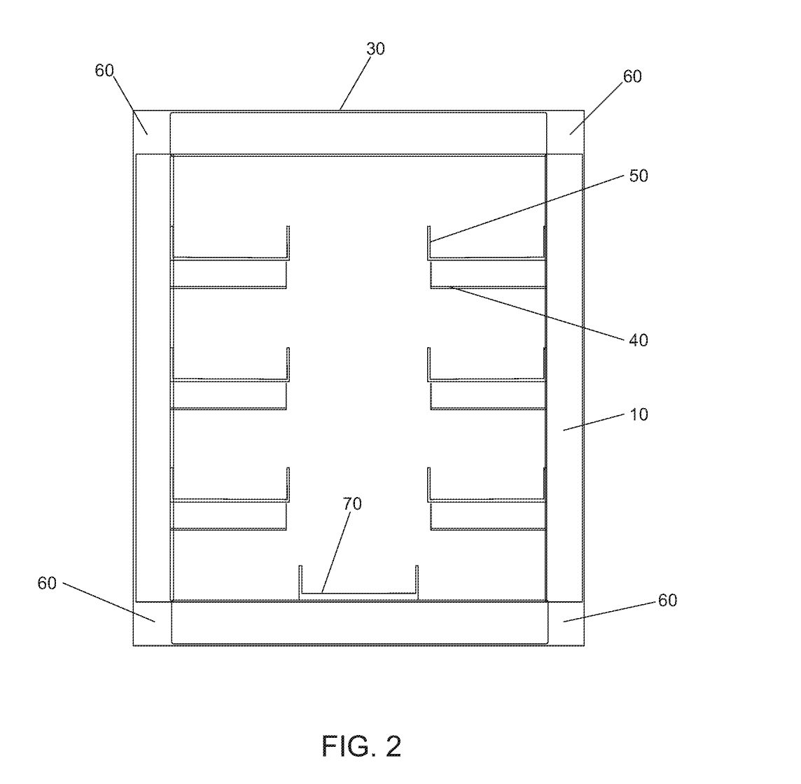

FIG. 3 is perspective drawing of another embodiment of Module.

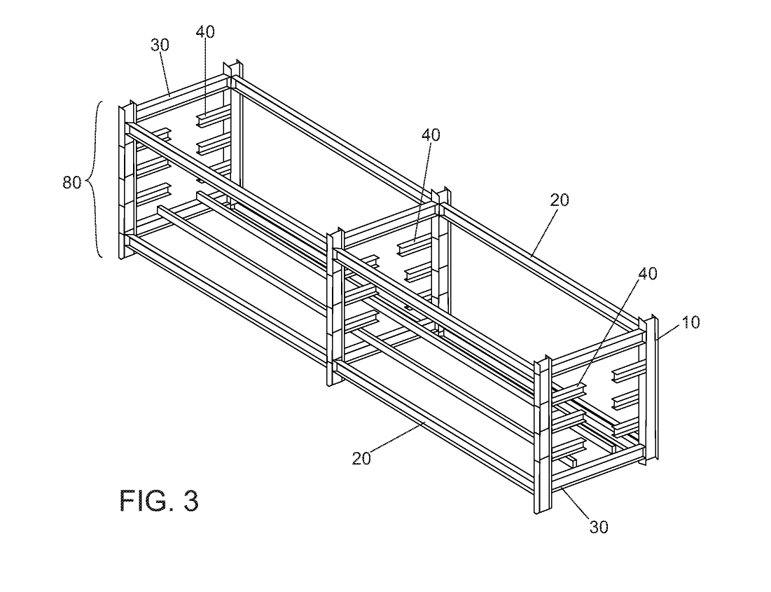

FIG. 4 is a perspective drawing (not to scale) of a specific embodiment of a single-layer module, populated with pipe or conduit of mixed sizes.

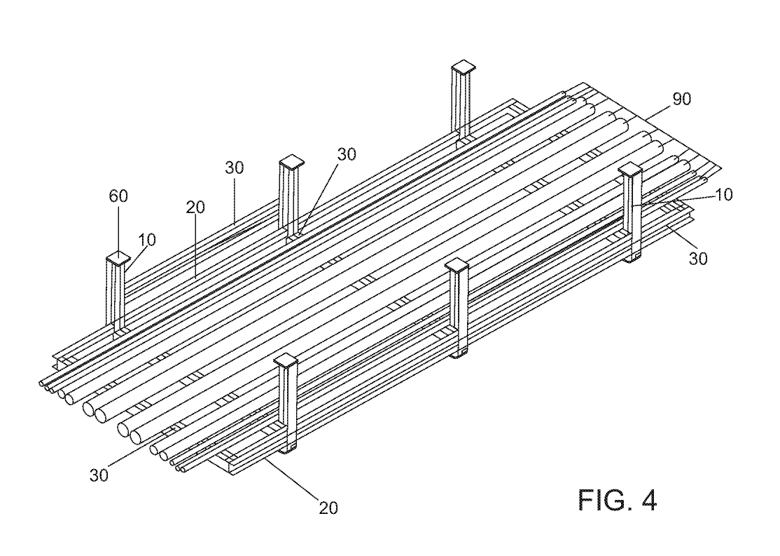

FIG. 5 is a perspective drawing (not to scale) of a generic embodiment of an underlying portion of a facility made of Support Framework Structures with a Module of this invention stacked and installed on top.

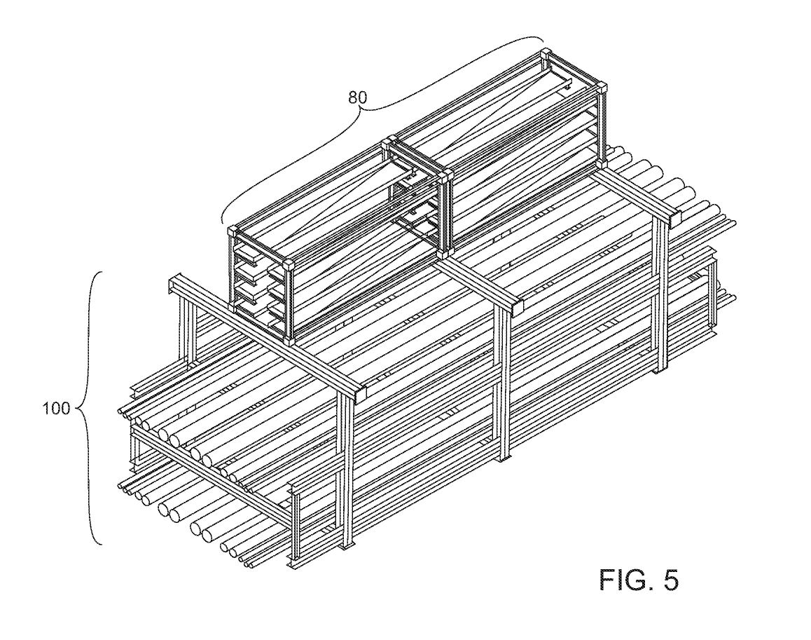

FIG. 6 is a similar perspective drawing (not to scale) of a generic embodiment of an underlying portion of a facility made of Support Framework

Structures with a Module of this invention stacked and installed on top.

FIG. 7 is a perspective drawing (not to scale) of a Module populated and configured as a railyard trans-shipment gantry system (portion) or a well-pad service module.

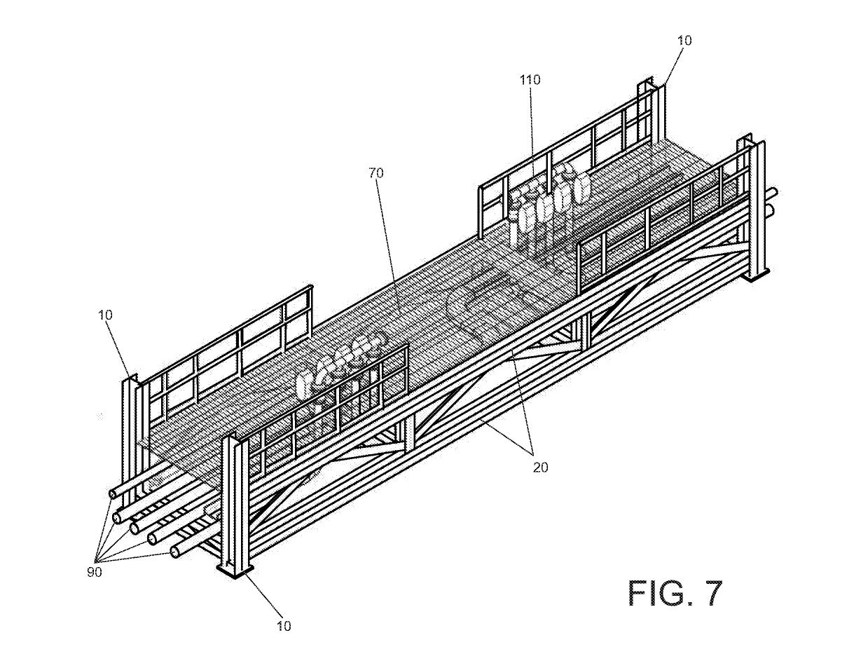

### DETAILED DESCRIPTION OF THE INVENTION

The effective quality of the large-scale facility for industrial equipment as an end-product of the disclosed system of design, manufacture, and modularization of prepopulated or partially prepopulated modular components as a container, and then shipment and transshipment as a container, can provide higher predictability of delivered componentry, better overall safety and lower cost of sub-component manufacture, fabrication and assembly labor and materials, with accurate logistics for just-in-time delivery to the eventual facility site, and higher quality of the larger assembly of the prepopulated modular components into the constructed facility can result from the ability to design and manufacture exact or close-tolerance prepopulated modular subcomponents which are then capable of more exact assembled large subassemblies, which in turn enables a user to achieve higher safety for all involved in the construction and commissioning of the eventual facility, and better ease of assembly of large subassemblies at remote sites.

By designing module subassemblies to be built off-site but within container-transportable range of industrial facilities for assembly on the remote construction site of the industrial facility, the modules or sub-structures designed to be built at one or more purpose-built manufacturing/fabrication/assembly facilities in controlled circumstances, which manufactured and prepopulated modular subassemblies 80 are built to be fitted and fixed together, with other components, but also to meet Seacan specifications in terms of spatial envelope (for example 20′ or 40′ long×8′-0″ wide×8′-6″ high), a significant portion of the industrial facility at the eventual location can be built from pre-populated containerized modules, prepopulated at least partially with pipe, conduit, electrical, sensing, metering and signal wiring and apparatus, referred to elsewhere here as features associated with the eventual facility, in a module assembly yard and which subassemblies can be finally assembled in construction of industrial facilities at remote sites.

Additionally, the prepopulated modular subassemblies 80 of which the facility is comprised may be disassembled from the facility on decommissioning or alteration of the facility, inventoried, and may be moved from one site to another as components, in a modular basis, as a multi-modal container configuration again for shipping and handling and inventorying, to accommodate facility movement, recycling and recovery. This can take advantage of the positive features of prefabricated construction, Seacan logistics and material-management, and may reduce complexity, hazard, error rates, and increase portability and re-use potential compared with prior art oilfield facilities construction modularization and techniques/processes (for example, more of the on-site work can be accomplished without scaffolding, at grade).

Modularized cable tray modules 80 built with Seacan dimensions and handling specifications, for instance 20 feet long×8 feet wide×8′6″ high and with integral Seacan cast connectors 60 or lugs at appropriate corners, may be manufactured anywhere in the world and shipped directly to a final industrial scale facility construction site for inclusion in the facility. Once delivered, when needed, container-sized cable tray modules 80 can be lifted and placed onto the top of the facility 100 under construction using much lighter crane or lifting equipment with standard container lifting gear and attachments, to the attachment points 60 of each module 80 of the invention into the facility's structure 100 and associated equipment.

The module's steel structure and tray is of standardized design and can be made anywhere in the world that is suitable. Standard modes of container transport, which are readily available and permitted, may be used at each step of the module's journey from manufacture to end-use at site. No further work may be required at a local or regional module yard, and these modules 80 can follow container logistics logic and be stored or stockpiled and made ready for use in more just-in-time supply-chain fashion, with virtually no queueing required for further work or finishing. The cable-tray modules 80 may be prepopulated with associated equipment 90,110.

The modules 80 arrive on site, and can be picked up with a container frame by light lifting equipment and placed where needed 100, typically butted up to a previously placed and installed cable tray module 80 on the top of the structure 100 of the industrial facility as it is built. The module may then be bolted or welded into place, and becomes stable, and the associated equipment 90,110 can then be interconnected with the existing facility 100 (for instance, to the adjacent pre-installed abutting module). The modules 80 are inherently safe (or can be) due to the design of included walkways 70 with strategically placed cable trays 50. Scaffold is not required when using this system, as the inherent characteristics of this design protects workers from fall heights. Assembly can, in large part, be accomplished by workers situated within the module 80, not external to the building, working from a protected area 70 away from fall zones.

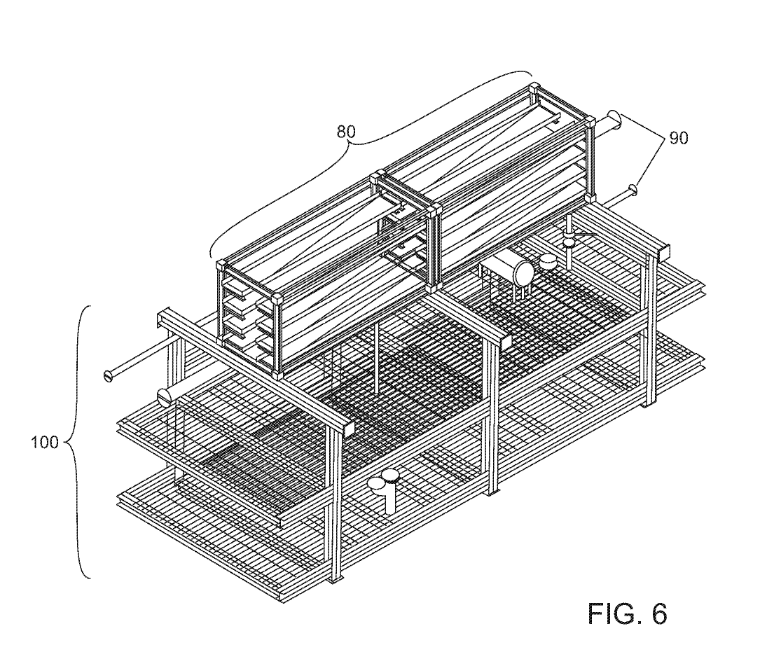

In the above example, the module 80 discussed is a cable-tray 50 module. Similar modules can include modules which are pipe-rack and associated valve and control fittings and equipment (FIG. 6); modules which are railyard gantry 110 and transloading equipment for transfer of fluids such as bitumen, heavy or other hydrocarbons and/or diluent and fuel, with associated pipe, conduit, control, sensor, metering, valve, vapor collection, electrical, pump, heater and other equipment.

Each module 80, as noted, is built to fit the dimensional envelope of an intermodal container or Seacan, with lifting lugs 60 at appropriate corners so that it may be shipped and handled and stored as a container. The container can be rotated 180 degrees horizontally (about its vertical axis) to suit connection and orientation requirements at an eventual facility site, for assembly and hookup, and may be equipped with relief or control valves on an outboard side or end if required for the eventual facility's design—end modules can be customized or custom configured to suit the facility's requirements.

Modules 80 are lifted with a container handling spreader assembly by suitable crane on site, and placed on the lower elements of the constructed facility 100, as it is assembled and constructed with these modules. The added module 80 is bolted or welded into place through the bottom 70 of the module 80, permitting this work to be done in a protected space, away from fall zones, to preserve worker safety and avoid necessity of using specialized harness and fall equipment. Connections are made, and the structure is made very quickly inherently safe and stable. Walkways 70, as required, are constructed and included with the modules within the cable trays/pipe-rack and associated equipment 50, 90, 110, and the walkways abut each other as the module abuts to a previously installed adjacent module or facility feature. There is no further construction required for interconnection between the modules. A next adjacent prepopulated module 80 may then be installed, fixed in place and interconnected, and so forth. Conventional methods of leaving 6 m gaps between standard construction of racking can be avoided, making assembly faster and safer. The prepopulated modules 80 should not require added scaffolding other than temporary access stairways or lifts to allow workers to reach the modules for cable pulls and interconnection work; the modules are placed end-to-end 80 and side-by-side (as required) and may be stacked in rows, and a welder or iron worker welds or bolts them into place from within the safety of the module's interior space.

Although typical Seacans are skinned so that their contents are sealed from view, access, and from the environment, the module of the present invention is not necessarily skinned or sealed, but its assembled components may be in the open, or may be painted, coated, or otherwise protected. Alternatively (or in addition), the module of this invention may be skinned or sealed by installation of exterior wall panels to the set of structural frame members comprising the module.

The components of the containerized module may be standardized as well as the configuration of the assembly, and any included other associated equipment, conduit, piping and the like 90. Under this design a welded structural framework 10, 20, 30 may be formed with major joints being moment connections with typical support spacing, to avoid deformation of the module during transport and handling.

Some individual components may be over designed for their actual load but uniformity of size (depth and kg/m) keeps the cost per tonne lower. All structural framework components of these modules can be made pre-drilled with uniformly dimensioned splice plates so that the modules can be rotated, mirrored or inverted as the requirement may be. This can allow for the interchange of modules as required to meet overall facility construction schedules. The design is based upon a stackable configuration to allow installation of all components by personnel within 1.5 m of grade; most fitting and welding locations to interconnect pipes, equipment and conduit, gang-way, cable tray or other features may be carried out within 1.1 m of grade. This can be provided by:
1. Installation of any grating 70 required for higher assembly by workers while standing at grade;
2. Lifting a second assembly onto a first assembly with a minimally sized crane and bolting together assemblies from external scissor lifts or JLG type worker lifts;
3. Once delivered to eventual facility construction site the prepopulated module subassembly may be equipped with fittings to support external scaffolding and not only supports components but also may support added planking for access for welding, bolting or other means of fastening (virtually no scaffold frames are required). There should be no requirement for unsupported components, nor for extrinsic bracing during shipping nor to be added or removed at the facility site.

No scaffolding may be required until the individual modules are stacked together. At that point vertical members may be bolted to cantilevered beams of some modules, and a horizontal beam can be installed on adjoining modules, between them to form a structure for scaffold planks to be slid into to form a work platform required to join pipes, and fittings when those are populated on the subassembly or assembled facility.

Parts associated with an example cable-tray module
(a) 4×transverse structural member, 1 top, 1 bottom and 2 ends
(b) Industry-standard container cast corner lifting lugs
(c) Longitudinal structure members—1 top, 1 bottom on each side
(d) Vertical structure member at each corner
(e) Simple beam cable tray 30″ up to 30″ on 1 side and 24″ on the opposite side
(f) Cantilevered steel tray support 1 per tray per end
(g) Steel grating walkway

The specification and examples should be considered as exemplary and not themselves limiting. The scope of the invention is limited only by the claims.

| Numeral | Description | FIG(S). |
|---|---|---|
| 10 | Post | 1 |
| 20 | Longitudinal Beam | 1 |
| 30 | Transverse Beam | 1 |
| 40 | Cantilever Beam | 1 |
| 50 | Tray | 1 |
| 60 | Corner Casting | 1 |
| 70 | Flooring insert | 1 |
| 80 | Module Whole | 2 |
| 90 | Conduit, Pipe | 4 |
| 100 | Underlying Facility Structure | 5 |
| 110 | Railyard Gantry Equipment | 7 |

Other embodiments and uses of the invention will be apparent to those skilled in the art from consideration of the specification and practice of the invention as disclosed herein.

What is claimed is:

1. A module, being a prepopulated subassembly of components sized and made to form and function as a standardized inter-modal shipping container, the module capable of use during transport and inventory as a standard shipping container, the module's components comprising:
a. A structure of connected horizontal longitudinal beams, horizontal transverse beams and vertical posts forming a support structure to be a part of an industrial facility and populated with one or more of the following fixtures:
i. cantilevered arms attached to the vertical posts extending inwardly partway toward the longitudinal internal axis of the support structure, the posts having standard shipping container cast corner lugs both top and bottom;
ii. walkways or flooring suspended between adjacent horizontal beams to form workspace for workers;
iii. equipment associated with the subassembly's purpose, being one of more of: conduit, pipe, shelving, catwalk, manway, valve, meter, gantry equipment, manifold, pump, automated controls, system interface equipment for operators, connectors, vapor control means, vents, gates, or ramps;
b. the module being manufactured of the connected beams and posts and then populated by assembling and fixing fixtures at or near the place of manufacture, c. the module being designed as a subassembly for eventual assembly at a site as part of a facility for large-scale industrial equipment and associated features.

2. The module of claim 1 fabricated and stockpiled in advance of need to allow reaction to market or project timing requirements.

3. The module of claim 1 which when assembled into an eventual industrial facility provides a portion of a cable-tray set for a cable run for the facility.

4. The module of claim 1 which when assembled into an eventual industrial facility provides a rail-car gantry system of pipes, valves, overhead moveable fittings, pumps, sensors, metering, conduits, heating, transfer control, safety and scads systems.

5. The module of claim 1 which when assembled into an eventual industrial facility provides, with a series of other mating modules, a system of cable-trays, catwalks, conduits and pipeways to form a longer cable and conduit management and support system.

6. The module of claim 1 protected by at least one of: the module may be skinned, or the framework structures may be coated, painted, covered or otherwise isolated from the ambient environment.

7. The module of claim 2 where at least one post-and-beam support structure component in the module is capable of bearing a 10 metric ton load on each post.

8. The module of claim 1 where the facility for large-scale industrial equipment and associated features is one of: a crude oil transshipment railyard, a SAGD steam generation and production facility, a heavy oil upgrader, a refinery, a chemical processing or food processing plant, a petro-chemical facility, and mining and mineral processing facilities.

9. The module of claim 1 where several modules are assembled at the eventual destination to facilitate one of : gas compressor, steam generator, pumps, air compressors, separation or process vessels, heat exchangers, absorption towers, dessicant beds, controlled chemical reactors, water treatment equipment, and associated features.

10. The module of claim 1 which comprises:
a. Safety Relief valve and tubing above equipment;
b. Home run racks from well pads to central processing facilities;
c. Spur racks in large processing plants;
d. Primary racks in Natural Gas Liquids extraction plants; or
e. Primary racks in tank farms.

11. The module of claim 1 further comprising cable-tray components installed on matching horizontal elements attached to the inside side of the posts.

12. The module of claim 2 further comprising one or more of: wiring for signal or power, fibre-optic conduit, electrical conduit, sensors, control systems.

13. The module of claim 1 where more than one such module is assembled at a facility site onto foundations or onto lower levels of the eventual facility, the modules adjacent and end-to-end longitudinally or perpendicularly aligned, and then attached, where flooring present in the modules may be connected between modules by adding inter-modular flooring sections to form continuous flooring within and between the adjacent modules.

14. The module of claim 1 where more than one such module is assembled at a facility site onto foundations or onto lower levels of the eventual facility, the modules adjacent and end-to-end longitudinally or perpendicularly aligned, and then attached, where racking present in the modules may be connected between modules by adding intermodular racking segments to form continuous racking within and between the adjacent modules.
